(19) United States
(12) Patent Application Publication
(10) Pub. No.: US 2009/0125521 A1
(43) Pub. Date: May 14, 2009

(54) SYSTEM AND METHOD FOR REPRESENTATION OF MULTIPLE-IDENTITIES OF A USER IN A SOCIAL NETWORKING ENVIRONMENT

(76) Inventor: William Petty, San Francisco, CA (US)

Correspondence Address: PERKINS COIE LLP, P.O. BOX 1208, SEATTLE, WA, 98111-1208, US

(21) Appl. No.: 12/039,025

(22) Filed: Feb. 28, 2008

Related U.S. Application Data
(60) Provisional application No. 60/986,504, filed on Nov. 8, 2007.

(51) Int. Cl. G06F 17/30

(52) U.S. Cl. 707/9; 707/E17.007

(57) ABSTRACT

Systems and methods for representation of a user in a social networking environment are disclosed. In one aspect of the present disclosure, a method of a social networking environment includes managing anonymity levels of a set of user content provided by a user to the social networking environment. The set of user content includes a first content subset having a first anonymity level corresponding to a privacy setting of a public status, a second content subset having a second anonymity level corresponding to a privacy setting of a peer status, and/or a third content subset having a third anonymity level corresponding to a privacy setting of a private status.

### CROSS-REFERENCE TO RELATED APPLICATIONS

This Application is a Non-Provisional of Provisional 35 U.S.C. §119(e) application 60/986,504 entitled “Method and System for a Multiple-Persona Model of Personal Representation and Social Interaction on Community Internet Sites” filed on Nov. 8, 2007 and is hereby incorporated herein by reference.

### BACKGROUND

Many community Internet sites, for example, social networking sites, allow their users to represent themselves on the site as a basis for interacting socially with other members. Typically, this representation of the user's self takes the form of a single “member page.” The user customizes this page for personality representation. For example, the user may populate the home page with personal information, photos, graphics, and/or any other content that the user believes is suitable for self-representation. Community sites generally provided means whereby some areas of a member page can be made accessible only to other users designated by the user as having a particular type of relationship (e.g., friends, family, contacts, etc.) thus protecting certain private information from public access.

However, this example model may be at odds with real-life social interactions. For example, in real life social interactions, people can choose to show different personas and aspects of themselves to different people depending on the situation and context. Some people may maintain different social circles, some of which may not come into contact with one another, for example, those that correspond to different activities and interests.

In real world social interactions, a person might have important friends who would not be introduced to a potential employer or a judgmental parent. If a person is going to a job interview, he may dress in a certain way to display a more formal aspect of his personality. If he is enjoying time with friends he may dress in differently and portray a more relaxed aspect of his personality. If he is engaged in self-examination or sharing an extremely private part of himself with a confidant, the wardrobe may be less relevant, whereas an authentic aspect of his personality may be at the fore.

Another human tendency that is typically not accommodated by the current model is the willingness to reveal personal information when anonymity can be guaranteed to a certain extent. Anonymous sharing of personal/private information provides an outlet for human impulses that may be frustrating and destructive and further allows two anonymous individuals to communicate and become friends over issues that may represent deep currents in their lives. Anonymous sharing is generally difficult under the current model of web-based social networking, where friends, family, colleagues, and the anonymous general public meet/interact with an individual on a single member page.

Some users, in trying to confide in peers and intimates using the current model, may accidentally reveal information that they would not have shared with potential employers, academic institutions, and other figures of authority. As users gradually become aware of this potential pitfall, a cautious approach to public self-revelation has become the norm for many users in their personal representations and interactions on community Internet sites.

This approach, though understandable given the limitations of the current model, may deprive users of potentially rich social experiences, with the result that community social networking sites remain primarily a way for people to interact electronically with their existing real world friends. The current model has not enabled the Internet as a medium to facilitate web-based relationships based on mutual understandings.

### SUMMARY OF THE DESCRIPTION

Systems and methods for representation of multiple-identities of a user in a social networking environment are described here. Some embodiments of the present disclosure are summarized in this section.

One aspect of the present disclosure includes a method, which may be implemented on a system, of, a social networking environment. One embodiment includes, managing anonymity levels of a set of user content provided by a user to the social networking environment. The set of user content typically include a first content subset having a first anonymity level corresponding to a privacy setting of a public status, a second content subset having a second anonymity level corresponding to a privacy setting of a peer status, and a third content subset having a third anonymity level corresponding to a privacy setting of a private status.

One embodiment further includes associating a first username, a second username, and a third username with the user; wherein the first username is associated with the first anonymity level, the second username is associated with the second anonymity level, and the third username is associated with the third anonymity level, receiving newly submitted content from the user, and/or assigning an anonymity level to the newly submitted content based on designation by the user. The set of user content may generally be accessible by another user; wherein the accessibility comprises one or more of, searchability and visibility. The first username, the second username, and the third username are not mutually identifiable by the another user. In most instances, the first content subset, the second content subset, and the third content subset, are not mutually identifiable by the another user.

One embodiment further includes, providing access to the first content subset to another user having the first type relationship with the user at the second anonymity level, when in accordance with specification by the user. The privacy setting of the public status, the privacy settings of the peer status, and the privacy settings of the private status are usually individually adjustable by the user.

One embodiment includes, presenting content of the first content subset to another user and/or providing accessibility to the legal identity of the user to another user. The legal identity can be determined from one or more of, the legal name of the user and first username of the user. Web-based communications can be facilitated between the user and the another user

One embodiment further includes, presenting content of the second content subset to another user, determining a relationship status of the another user with the user at the second anonymity level, and/or providing accessibility to the legal identity of the user to the another user responsive to determining that the relationship status is of a first type. The legal identity may be determined from one or more of, the legal name of the user and second username of the user. In addition, the relationship status of the first type is typically a mutual relationship between the user and another user.

One embodiment further includes, providing accessibility to the second username of the user to another user responsive to determining that the relationship status is not of the first type. The legal identity may not determine-able from the second username. Accessibility to the first username of the user to another user may be provided responsive to determining that the relationship status is of the first type at the second anonymity level. One embodiment includes, facilitating web-based communications between the user and another user responsive to determining that the relationship status is of the first type at the second anonymity level.

One embodiment includes, presenting content of the third content subset to another user, determining a relationship status of another user with the user at the third anonymity level, and/or providing accessibility to the legal identity of the user to the another user responsive to determining that the relationship status is of a first type. The legal identity may be determined from one or more of, the legal name of the user and third username of the user. Furthermore, the relationship status of the first type is a mutual relationship between the user and another user.

One embodiment includes, providing accessibility to the third username of the user to another user responsive to determining that the relationship status is not of a first type. Web-based communications between the user and another user can be facilitated responsive to determining that the relationship status is of a first type.

A further aspect of the present disclosure includes a method, which may be implemented on a system, of, a web-based social networking platform. One embodiment includes, creating a plurality of web-spaces that are individually accessible by a user using a plurality of unique identifiers; wherein each of the plurality of web-spaces is individually associated with each of the plurality of unique identifiers, receiving a request from the user to access one of the plurality of web-spaces, determining the web-space of the plurality of web-spaces based on a unique identifier of the plurality of unique identifiers submitted by the user to generate the request, and/or providing the user with access to the web-space of the plurality of web-spaces.

One embodiment includes, viewing content submitted to the web-space of the plurality of web-spaces and/or editing the content submitted to the web-space of the plurality of web-spaces. The access of the web-space of the user typically includes, facilitating anonymous interaction with a first set of users having a first type of relationship with the user in the web-space and/or facilitating non-anonymous interaction with a second set of users having a second type of relationship with the user in the web-space. The access of the web-space of the user further includes, receiving content submitted by the user and/or associating the content with the web-space of the plurality of web-spaces specified by the user; wherein the content is associated with one of the unique identifier of the user associated with the one of the plurality of web-spaces.

One embodiment further includes, providing the first set of users with access to the content anonymously and/or providing the second set of users with access to the content non-anonymously.

Another aspect of the present disclosure includes a method, which may be implemented on a system, of, providing the user with access to another web-space of the plurality of web-spaces, facilitating anonymous interaction with a third set of users having a first type of relationship with the user in the another web-space, and/or facilitating non-anonymous interaction with a fourth set of users having a second type of relationship with the user in the another web-space. The accessibility of the content associated with the web-space of the plurality of web-spaces to the third and fourth sets of users are generally adjustable by the user. In addition, accessibility of content associated with another web-space of the plurality of web-spaces to the first and second sets of users are adjustable by the user.

One aspect of the present disclosure includes a system including, a user database to store user information, a content database to store a plurality of content submissions, a user account module to manage a plurality of identities associated with a user in a social network, a privacy setting module to track and enforce the privacy settings associated with each of the plurality of identities associated with the user in the social network, and/or a relationship tracker agent to manage a plurality of sets of contacts of the user associated with each of the plurality of identities.

One embodiment of the system includes a communications module to facilitate web-based communications between the user and a contact of the plurality of the sets of contacts of the user. The communications module may further manage anonymity level of the user in the web-based communication based on the identity of the plurality of identities that the contact is associated with.

A computer implemented social networking system, the social networking system characterized in that a user has a plurality of identities, each identity having associated content, and each identity having an associated anonymity level which determines how other users are entitled to interact with each identity and associated content, and how other users perceive each identity.

The present disclosure includes methods and systems which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

FIG. 1 illustrates a block diagram of a plurality of client devices, web application servers, and a host server for representing multiple user identities in a social networking environment, coupled via a network, according to one embodiment.

FIG. 2 depicts a block diagram illustrating an example system for representing multiple user identities in social networking environment; the system includes a host server coupled to a user database and/or a content database, according to one embodiment.

FIG. 3A depicts a block diagram illustrating an example of a user database that stores user profile information, including account information and/or privacy settings associated with the account, according to one embodiment.

FIG. 3B depicts a block diagram illustrating an example of a user database/content database that stores user content based on the associated persona of the user, according to one embodiment.

FIG. 4 illustrates an example screenshot of a user interface for accessing individual web-spaces associated with each of the user's multiple-identities, according to one embodiment.

FIG. 5 depicts a flow diagram illustrating an example process for assigning anonymity levels to user submitted content, according to one embodiment.

FIG. 6A depicts a flow diagram illustrating an example process for facilitating interactions at a first anonymity level (e.g., public status) between the user and another user, according to one embodiment.

FIG. 6B depicts a flow diagram illustrating an example process for facilitating interactions at a second anonymity level (e.g., peer status) between the user and another user, according to one embodiment.

FIG. 6C depicts a flow diagram illustrating an example process of facilitating interactions at a third anonymity level (e.g., private status) between the user and another user, according to one embodiment.

FIG. 7 depicts a flow diagram illustrating an example process of creating web-spaces individually user accessible using unique identifiers representing multiple-identities, according to one embodiment.

FIG. 8A depicts flow diagrams that illustrate example processes of content access in the web-space, according to one embodiment.

FIG. 8B depicts flow diagrams that illustrate example processes for providing anonymous or non-anonymous interactions among users based on the types of relationships that exist among the users in another web-space, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for enabling a user to express multiple aspects of his/her persona through managing multiple-identities in a web-based social networking environment.

In one aspect, the present disclosure relates to allowing a user to create, manage, and/or otherwise access multiple accounts in a social networking environment.

In some instances, multiple accounts are employed to represent different aspects of a user's personality to other users of varying degrees of closeness. The user can designate the number of accounts to create and may create a unique username for each account. The username may serve multiple purposes in the social networking environment. For example, the username can be used by the user to logon to one of the user's multiple accounts. When a user is logged on to one of the accounts that the user owns, the user can populate the web-pages of the account with information that the user feels is representative of a particular aspect of the overall personality.

In one aspect, the present disclosure relates to management and/or enforcement of privacy settings of each of the user's accounts in the social networking environment.

Typically, the user can access multiple web-spaces using multiple usernames for self-expression in the social network. Generally, the multiple web-spaces that represent various aspects of a user's personality are not cross-identifiable. For example, the user can have different sets of contacts affiliated with each of the user's account. Depending on the type of affiliation and/or user settings, the set of contacts may be able to access the user's true identity (e.g., real name, legal name, etc.). Multiple types of affiliations (e.g., relationships) can exist between the user (e.g., owner) of a particular account and visitors of that account. Generally the type of affiliation will determine whether the identity of the account owner is accessible to a visitor. The type of affiliation may further determine the content that the visitor user can access in a particular web-space. For example, a web-space may have content designated for access (e.g., viewing and/or commenting) only by visitors having a particular type of affiliation (e.g., a friend and/or a family member) with the user in that particular web-space.

For example, a visitor user that is a friend with the account user in a particular web-space may know the real identity of the account user whereas a visitor user that is not a friend may not have access to information that would reveal such data. In general, content in a web-space is visible to most visitors. However, the availability of the owner's identity to visitors will generally depend on the particular web-space and the default/customized privacy settings.

Visitor users that have an affiliation with one of a user's accounts may or may not have an affiliation with another account of the same user. These settings may be customized at the owner user's discretion for each account, individually.

The multiple accounts of a user are usually differentiated from one another based on the level of anonymity desired by the user. For example, one account could be of a ‘public’ status, where the visitor users of the web-space corresponding to this account can readily access information that may directly or indirectly reveal the user's true identity, regardless of the visitor's relationship with the user. Another account could be of a ‘peer’ status, where content in the associating web-space is presented anonymously to most visitors except, in some instances, visitors having a particular type of relationship (e.g., a designated ‘friend’, a family member, etc.) with the user under this account. Additional levels of anonymity of the user in the social network are contemplated and are considered to be within the scope of the novel art of this disclosure. Each level may have privacy settings that are different from or similar to the examples given above. On embodiment includes an account having a ‘family’ persona whose identity is revealed to all family members or a select group of family members. Similarly, a ‘collegiate’ persona could also be implemented where identities can be revealed to all or select colleagues and/or classmates.

In some instances, a friend of the user in the account having the peer status is by default a friend of the user in the account having a public status. In other instances, the contrary may be true. Generally, default privacy settings can be modified by the account owner to better reflect his/her way of self-representation/expression in a web-based social networking environment.

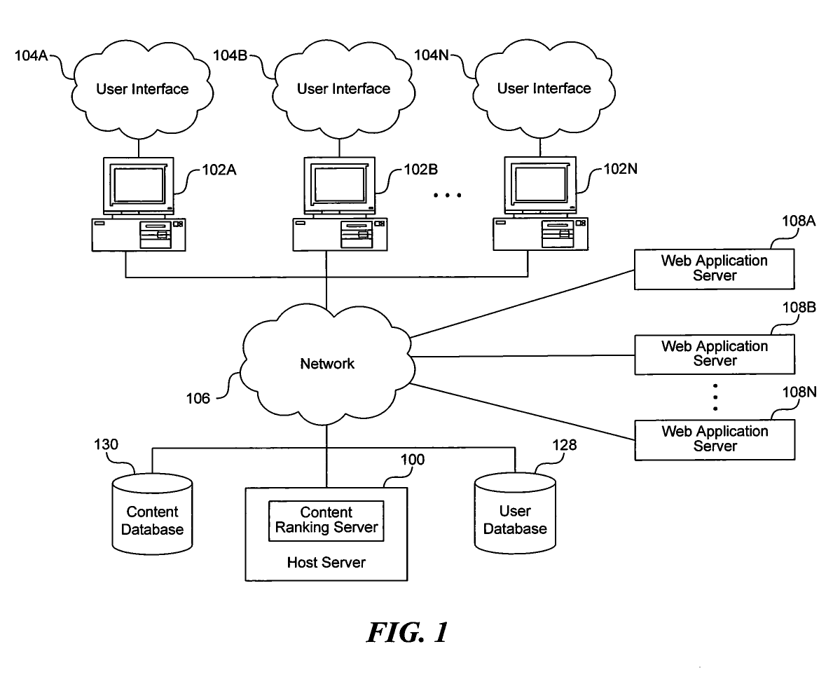

FIG. 1 illustrates a block diagram of a plurality of client devices 102A-N, web application servers 108A-N, and a host server 100 coupled via a network 106, according to one embodiment.

The plurality of client devices 102A-N can be any system and/or device, and/or any combination of devices/systems that is able to establish a connection with another device, a server and/or other systems. The client devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 102A-N are coupled to a network 106. In some embodiments, the client devices may be directly connected to one another.

The network 106, over which the client devices 102A-N may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2 G, 2.5 G, 3 G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client devices 102A-N can be coupled to the network (e.g., Internet) via a dial-up connection, a digital subscriber loop (DSL, ADSL), cable modem, and/or other types of connection. Thus, the client devices 102A-N can communicate with remote servers (e.g., web server, host server, mail server, instant messaging server) that provide access to user interfaces of the World Wide Web via a web browser, for example.

The user database 128 and content database 130 can store software, descriptive data, images, system information, drivers, and/or any other data item utilized by parts of the host server 100 for operation. The databases 128 and 130 may also store user information and user content, such as, user profile information, user settings (e.g., privacy settings), account associated with a user, user content, content metadata (e.g., privacy settings, associated account, type of content, file size, etc.). The user database 128 and content database 130 may be managed by a database management system (DBMS), for example but not limited to, Oracle, DB2, Microsoft Access, Microsoft SQL Server, PostgreSQL, MySQL, FileMaker, etc.

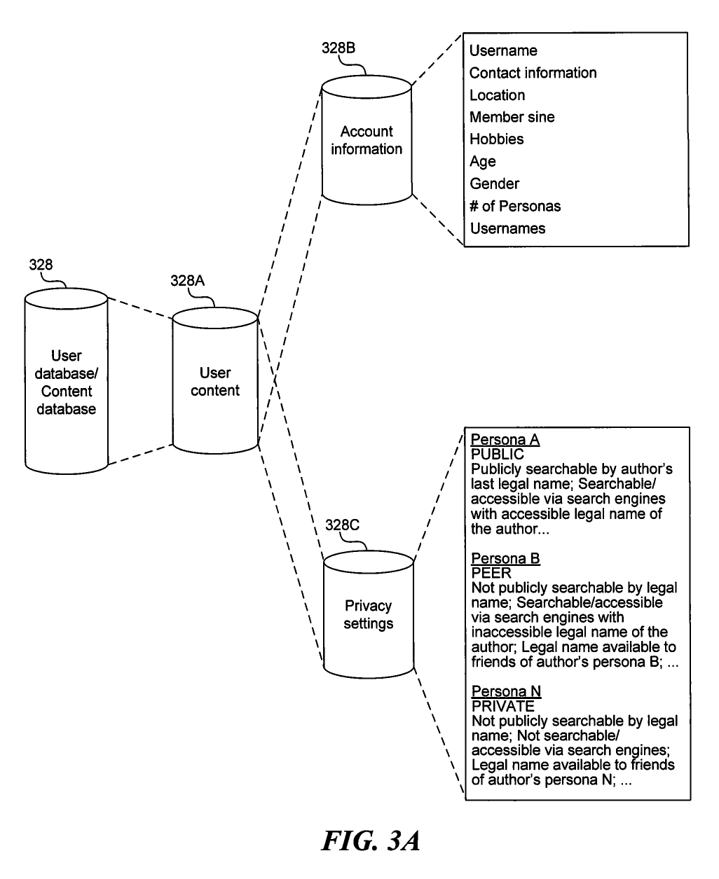

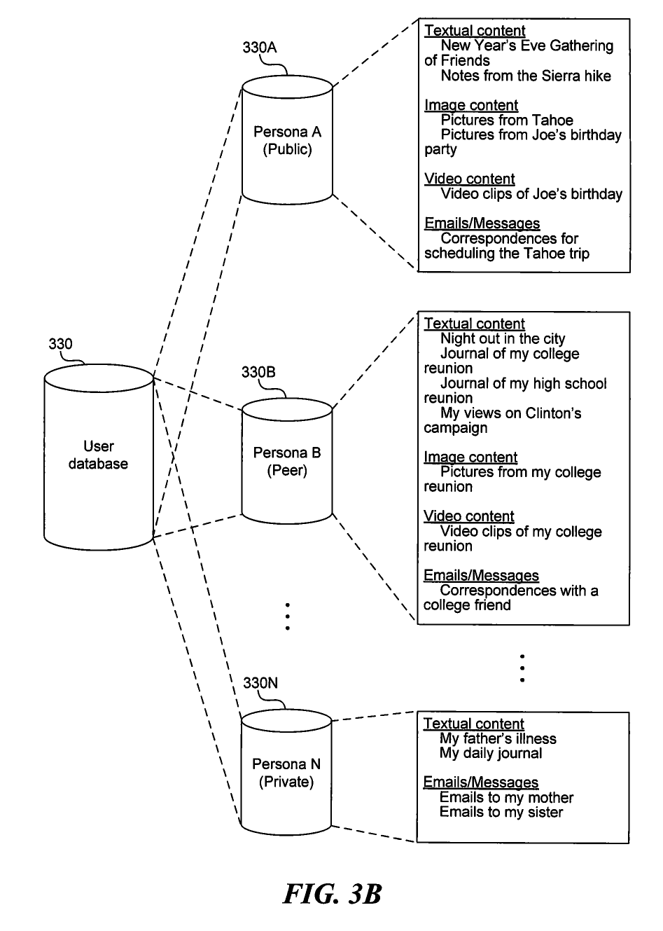

The databases 128 and 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 128 and content database 130 is further illustrated in FIG. 3A-3B.

The web application servers 108A-N can be any combination of software agents and/or hardware modules for providing software applications to end users, external systems and/or devices. The web application servers 108A-N can facilitate interaction and communication with the host server 100, or with other related applications and/or systems. For example, the web application servers 108A-N can receive content and/or commands from the host server 100. The web application servers 108A-N can further include any combination of software agents and/or hardware modules for accepting Hypertext Transfer Protocol (HTTP) requests from end users, external systems, and/or external client devices and responding to the request by providing the requesters with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP. NET, etc.).

In addition, a secure connection, SSL and/or TLS can be established by the web application servers 108A-N. In some embodiments, the web application servers 108A-N renders the web pages with graphic user interfaces. The web pages provided by the web application servers 108A-N to client users/end devices enable user interface screens 104A-104N for example, to be displayed on client devices 102A-104N. In some embodiments, the web application servers 108A-N also perform authentication processes before responding to requests for resource access and data retrieval.

The host server 100 is, in some embodiments, able to communicate with client devices 102A-N and/or web application servers 108A-N via the network 106. In addition, the host server 100 is able to retrieve data from the user database 128 and the content database 130. In some embodiments, the host server 100 manages representations of multiple-identities of a user in a social networking environment, for example, over a network (e.g., the network 106) for various users of the client devices 102A-N.

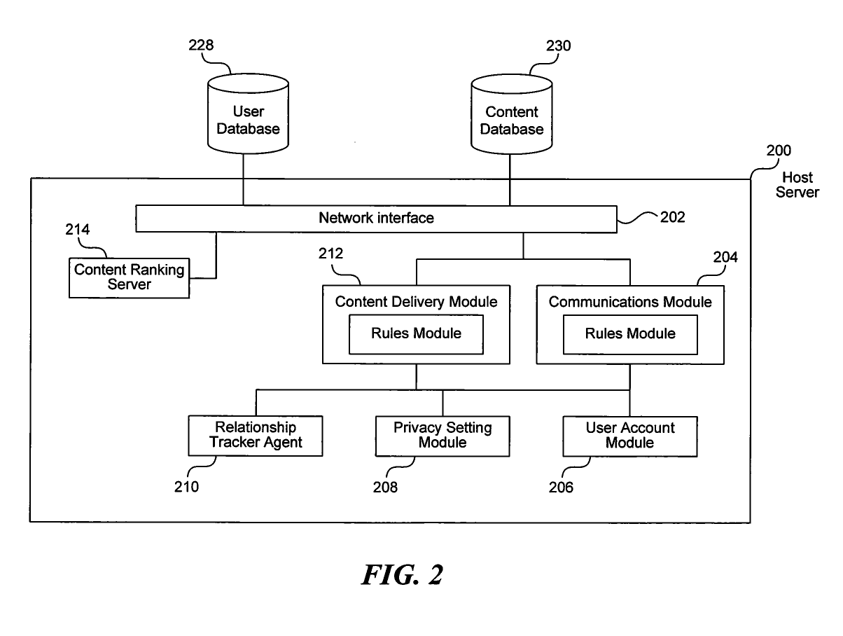

FIG. 2 depicts a block diagram illustrating a system for ranking content and selecting reviewers, the system to include a host server 200 coupled to a user database 228 and/or a content database 230, according to one embodiment.

In the example of FIG. 2, the host server 200 includes a network interface 202, a firewall (not shown), a communications module 204, a user account module 206, a privacy setting module 208, a relationship tracker agent 210, a content delivery module 212, and/or a content ranking server 214. Additional or less modules may be included. The host server 200 may be communicatively coupled to the user database 228 and/or the content database 230 as illustrated in FIG. 2. In some embodiments, the content ranking server 214, the user database 228 and/or the content database 230 are partially or wholly internal to host server 200.

In the example of FIG. 2, the network controller 202 can be one or more networking devices that enable the host server 200 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2, the host server 200 includes the communications module 204 or a combination of communications modules communicatively coupled to the network interface 202 to manage a one-way, two-way, and/or multi-way communication sessions over a plurality of communications protocols. In one embodiment, the communications module 204 receives data (e.g., audio data, textual data, audio files, etc.), information, commands, requests (e.g., text and/or audio-based), and/or text-based messages over a network. In one embodiment, the communications module receives communications from a network (e.g., Internet, wired and/or wireless network) initiated via a web-interface.

Since the communications module 204 is typically compatible with receiving and/or interpreting data originating from various communication protocols, the communications module 204 is able to establish parallel and/or serial communication sessions with users of remote client devices for data and command exchange (e.g., user information and/or user content).

In addition, the communications module 204 can manage log-on requests received from one or more users connecting to the host server 200 to logon to the social networking site, submit content, access their home pages, customize their home pages, communicate with other users, review content, and/or otherwise access content. Connections are typically maintained until a user leaves the site. In some instances, authenticated sessions are managed by the communications module 204.

For example, the platform may utilize a username/email and password identification method for authorizing access. The communications module 204 can gather data to determine if the user is authorized to access the system and if so, securely logs the user into the system. In other embodiments, other forms of identity authentication, include but is not limited to, security cards, digital certificates, biometric identifiers (e.g., fingerprints, retinal scans, facial scans, DNA, etc.) can be utilized and are contemplated and in accordance with this disclosure. A user may be able to specify and/or obtain a logon ID after subscribing or registering.

The communications module 204, in one embodiment, further manages communications among users of the social networking site. Since each user typically has multiple accounts in the network in which the user wishes to maintain varying levels of anonymity, the communications module tracks the rules associated with the account through which users are communicating via and enforces any privacy settings associated with the accounts. One embodiment of the communications module includes a rules module.

One embodiment of the host server 200 includes a user account module 206. The user account module 206 can be any combination of software agents and/or hardware components able to manage multiple accounts associated with each user in the social networking environment.

The user account module 206, in one embodiment, receives a user request to create multiple accounts to represent multiple-identities in the social network. The user is typically designated as an owner of each account created on his/her behalf. The user account module 206, in one embodiment, tracks each of the owner's accounts. The user account module 206 may, in some instances, internally generate unique identifiers for each of the owner's accounts. In addition, the user account module 206 may further prompt the user to submit unique identifiers for each account. In some embodiments, the unique identifiers correspond to usernames that also allow the user to log on to each account.

In some embodiments, the account manager module 206 further determines the desired anonymity level the owner wishes to maintain under each account. Predetermined anonymity levels may be associated with predetermined number of accounts for the user to select from during account sign up. Similarly, the user may specify the anonymity level to be associated with each of the owner's accounts. In some embodiments, a combination of using predetermined levels and user-specified levels are used. For example, the owner may use the attributes associated with the predetermined levels to generate a customized anonymity level. Attributes associated with anonymity levels determine access of other users (e.g., visitors) to content and personal information associated with the owner, based on, for example, the identity of the visitor and/or the type of relationship the visitor has with the owner.

One embodiment of the host server 200 includes a privacy setting module 208. The privacy setting module 208 can be any combination of software agents and/or hardware components able to, determine, adjust, store, track, and/or enforce privacy settings of various attributes associated with various anonymity levels of an owner's accounts.

The privacy setting module 208 is able to communicate with the user account module 206 to determine the anonymity levels associated with the owner's accounts. Generally the privacy setting module 208 has a record of a set of default settings that are adjustable. In one embodiment, the privacy setting module prompts the user to create new privacy settings and/or to adjust the default settings. Privacy settings typically determine the types of content in a particular account that visitors can view and/or otherwise access (e.g., edit, comment on, delete, share, etc.), based on the identity of the visitor and any relationship that may exists between the visitor and the user in the context of the account in question.

One embodiment of the host server 200 includes a relationship tracker agent 210. The relationship tracker agent 210 can be any combination of software agents and/or hardware components able to, determine, track, adjust, and/or update any pre-existing or new relationships between visitors and the owner in the context of each of the owner's accounts.

Generally, each account belonging to the same owner can be individually associated with different sets of contacts. That is to say, the owner can choose to add contacts to one or more of the owner's accounts, individually. The contacts associated with one account typically have access to at least some information provided by the owner in the context of the same account. For example, the owner may populate a homepage for the account in a particular way and upload content accessible via the home page. Contacts associated with an account may have default access to some of the information. Accessibility is typically adjustable by the owner.

The relationship tracker agent tracks the contacts (e.g., visitors) associated with the owner's accounts. Each of the owner's accounts, generally, appears to visitors as accounts that belong to different users. In other words, in general, a visitor who is a contact (e.g., friend, family) of one of the user's accounts won't necessarily be able to identify the same owner's other accounts by virtue of the visitor being a contact of one account.

The relationship tracker agent 210, in one embodiment, tracks, stores, and/or monitors the different types of relationships a visitor can have with the owner in the context of each separate account. Default types of relationships may exist. The owner may also specify customized types of relationships for each account. The types of relationships are generally associated with varying privacy levels that the owner wishes to maintain within an account. For example, a visitor who is a friend of the owner in a particular account as opposed to a visitor who is not a friend may have access to content that is otherwise not available for access. Additionally, the friend may have access to certain personal information of the owner that one who is not a friend cannot access.

One embodiment of the host server 200 includes a content delivery module 212. The content delivery module 212 can be any combination of software agents and/or hardware components able to, share the owner's content with visitors/other users in the social networking environment.

The content delivery module 212, in one embodiment, is able to communicate with the privacy setting module 208 and/or the relationship tracker agent 210 and processes content access requests from visitors. The content delivery module 212, based on the identity of the visitor, determines whether the content requested is delivered to the visitor, for example, based on the relationship between the visitor and the owner in the account which the content is requested from and/or the privacy settings on record for the particular type of relationship in the account in question.

Additionally, the content delivery module 212, can, in some embodiments, amend the content presented to the visitor based on the owner's preferences associated with the particular account and/or the type of relationship that exists between the visitor and the owner. For example, the content delivery module 212 may redact portions of the content that may reveal personal information/identity of the owner when the owner wishes to maintain anonymity.

One embodiment of the host server 200 includes a content ranking server 214. The content ranking server 214 is described with further reference to U.S. patent application Ser. No. ______, which is herein incorporated by reference.

The host server 200 can be implemented using one or more processing units, such as server computers, UNIX workstations, personal computers, and/or other types of computes and processing devices. In the example of FIG. 2, the host server 200 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the host server 200 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 200 without deviating from the spirit of the disclosure.

FIG. 3A depicts a block diagram illustrating an example of a user database 328 that stores user profile information 328A including account information 328B and privacy setting information 328C, according to one embodiment.

In the example of FIG. 3A, the user profile database 328A can store user profile data, including data related to user information and/or user account information. For example, user profile data can include descriptive data of personal information such as, but is not limited to, a first name and last name of the user, a valid email ID, a unique user name, age, occupation, location, membership information, age, gender, number of personas and/or their associated usernames, etc. User profile data may further include interest information, which may include, but is not limited to, activities, hobbies, photos, etc.

The user profile database 328A can further store data related to privacy settings 328C. For example, database 328C can store privacy settings (e.g. default and/or user configured) of a user's web-spaces associated with each of the multiple-identities (or, multiple-personas) in the social networking environment. Each user may have a number of identities in the social network and have different privacy settings for content associated with a different identity.

In one embodiment, user profile data stored in database 328A (328B and/or 328C) is explicitly submitted by the user. For example, when the user (e.g., visitor/service subscriber) subscribes for content reviewing services, a set of information may be required, such as a valid email address, an address of service, a valid credit card number, social security number, a username, and/or age, etc. The user information form can include optional entries, by way of example but not limitation, location, activity, hobbies, ethnicity, photos, etc. Privacy settings (e.g., level of user anonymity) of each account may have default specifications although, in most instances, are also user configurable/adjustable.

FIG. 3B depicts a block diagram illustrating an example of a user database/content database 330 that receives submitted content, according to one embodiment.

The user database/content 330 can also store user content and/or data related to information of user content (e.g., user content data/metadata). User content and user content metadata can either be explicitly submitted by the user or provided via one or more software agents and/or hardware modules coupled to the database 330. For example, a user can upload user content to be stored in database 330. The user content can include textual content, audio content, image content, video content, messages, and/or emails. User content can also be recorded over a network in real-time or near real-time and stored in the database 330.

User content metadata can, in some instances, be automatically identified and stored in the database. In particular, content metadata include by way of example but not limitation, owner, author, topic, date created, date modified, genre, bit-rate, file size, tags, video quality, image quality, etc.

Content belonging to a user stored in the database 330 can be further organized according to the web-space to which the user added the content. Since each web-space typically corresponds to a user's different identity representation, content associated with different web-spaces usually are associated with varying privacy settings (e.g., public, peer, private . . . etc.). The varying privacy settings determine accessibility of content to other users having various levels of affiliations with the user under different identity representations. In the example of FIG. 3B, content submitted can be organized into at least three categories depending on the personas for which the content was submitted (e.g., based on user designation and/or based on the account in which the user was logged on at the time of submission). The content set can be categorized into a subset for the user's persona A (e.g., public persona), a subset for the user's persona B (e.g., peer persona), a subset for the user's persona N (e.g., private persona) . . . etc.

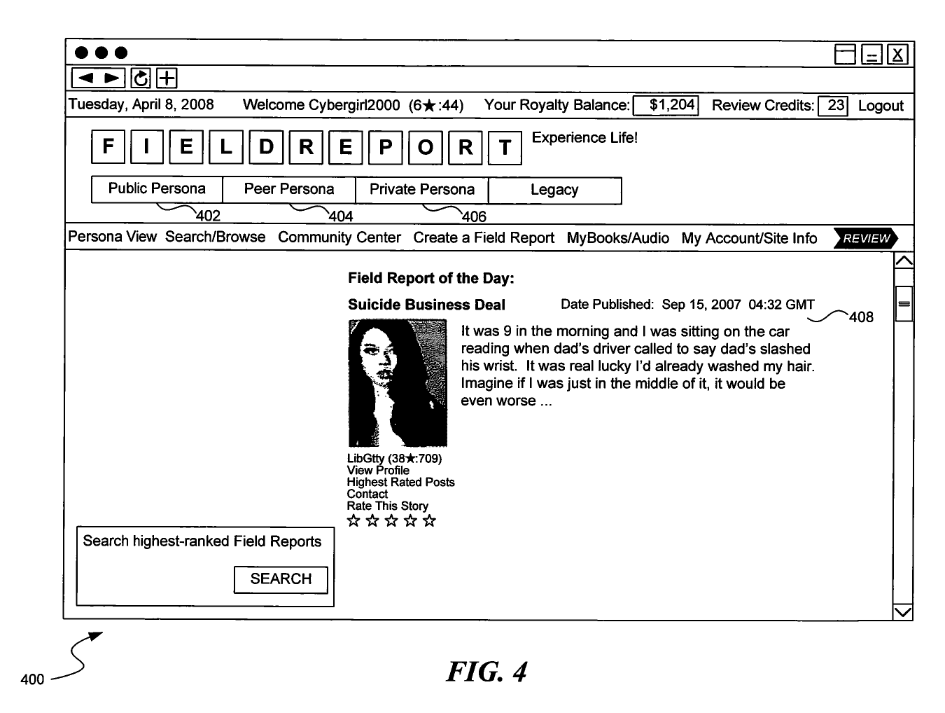

FIG. 4 illustrates an example screenshot 400 of a user interface for accessing individual web-spaces associated with each of the user's multiple-identities, according to one embodiment.

In the example of FIG. 4, the account owner (“Cybergirl2000”) maintains three accounts with varying anonymity levels (e.g., public persona, peer persona, and/or private persona). As shown, each account is individually accessible, for example, via the button 402 for the public persona, button 404 for the peer persona, and 406 for the private persona. If you click any of these buttons, you toggle into that specific persona, in the screen environment you were in before the toggle.

For example, when messages are viewed under the public persona, when the private persona button is selected, and the list of messages people have sent to the private persona can be displayed. Therefore, identities can be toggled while maintaining the nature of the current action being performed in the system

The user interface also allows the owner to view various user submitted content (e.g., content submitted by other users and/or the owner) and to access various services and/or functions provided by the social network. For example, the user may access functions including but not limited to those illustrated in the screenshot, such as, searching/browsing articles, participate in a community, write an article, access books/audio collections, and/or accessing account/site information.

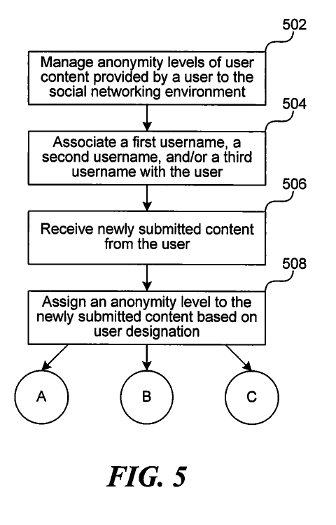

FIG. 5 depicts a flow diagram illustrating an example process of assigning anonymity levels to user submitted content, according to one embodiment.

In process 502, anonymity levels of user content provided by a user (e.g., owner user) to the social networking environment is managed. Anonymity levels typically refer to the degree to which other users (e.g., visitor users of the homepage of an owner user) can access personal information of the owner user. Personal information includes various data such as, but not limited to, birth date, age, address, home town, legal name, username, occupation, education, hobbies, etc.

In some embodiments, a predetermined number of anonymity levels are provided to a user in the social networking environment, where, each level may have a default privacy setting providing the user with various degrees of privacy. In some embodiments, the number of anonymity levels are user specified where each level is associated with customized privacy settings. In either situation, each anonymity level can be linked to a unique username specified by the user, for one or more purposes, including, but not limited to, account access, communication with other users, etc.

In process 504, multiple user names (e.g., a first username, a second username, a third username, and/or a third username . . . etc.) are associated with the user (e.g., owner user). The usernames may be user specified and are unique from usernames belonging to other users. In some instances, one of the usernames associated with the user may be the real name (e.g., legal name) of the user. The real name of the user can be associated with one of the accounts of the user.

In process 506, newly submitted content is received from the user. New content may be submitted via one or more of many communication modes, including, but not limited to, uploading to the website hosting the social networking, emailing to one or more predetermined addresses, text messaging, instant messaging, etc. In process 508, an anonymity level is assigned to the newly submitted content based on user designation. The user may specify the level at the time of submission. In addition, the user may specify the account with which the content is to be associated. The anonymity level of the account can then be associated with the content. The user can, in most instances, change the anonymity level of the content after submission and/or after designation (e.g., through specification and/or through adding the content to a different account with a different anonymity level).

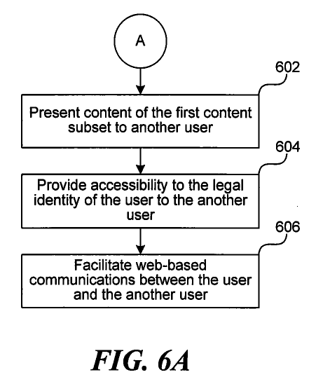

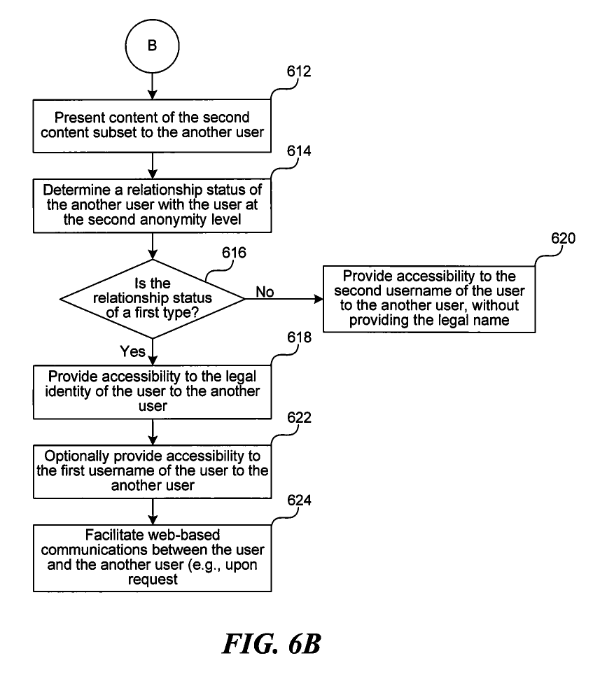

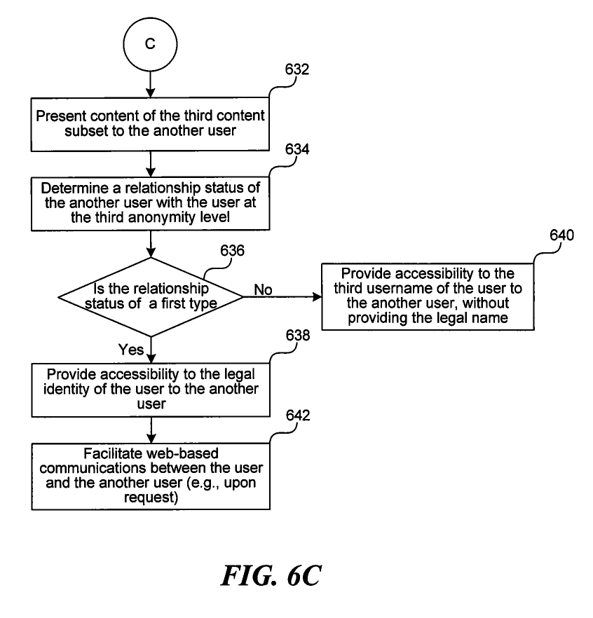

FIG. 6A depicts a flow diagram illustrating an example process of facilitating interactions at a first anonymity level (e.g., public status) between the user and another user, according to one embodiment.

In process 602, content of the first content subset is presented to another user. The first content subset, in this example, is associated with the first anonymity level having a public status. In this embodiment, a public status indicates that visitor users (e.g., another user) typically have access to the owner user's real identity (e.g., legal identity, legal name, etc.).

In process 604, accessibility to the legal identity of the user is provided to another user (e.g., a visitor). Access to the legal identity can be provided via one or more known and/or convenient ways, including, but not limited to, providing the legal name of the owner, providing access to the owner's personal information, providing a username that is substantially indicative of the legal name of the owner user, etc.

In process 606, web-based communications between the user (owner) and another user (visitor) is facilitated. Typically, the user's identity is known to the visitor user during communications that take place in the context of the first anonymity level (e.g., public). In some embodiments, this setting is modifiable by the owner. For example, the owner may desire that only visitors having a particular type of relationship with the owner may access the legal identity of the user during communications. Web-based communications include text and/or audio based-dialogue conducted in any known and/or convenient manner, including but not limited to, emails, messages, instant messages, voice messages, etc.

FIG. 6B depicts a flow diagram illustrating an example process of facilitating interactions at a second anonymity level (e.g., peer status) between the user and another user, according to one embodiment.

In process 612, content of the second content subset is presented to another user (visitor). The second content subset, in this example, is associated with the second anonymity level having, for example, a peer status. Privacy settings attributed to the second anonymity level may typically include some settings that by default, maintain more of the owner user's anonymity than the first anonymity level (e.g., public status). The default settings are generally user configurable/adjustable.

In one embodiment, a peer status indicates that visitor user by default have access to the owner's username. Whether the user's legal identity is accessible to the visitor user may depend on the type of relationship between the user and the visitor in the context of the second anonymity level. Therefore, in process 614, the relationship status of another user (e.g., visitor) with the owner at the second anonymity level is determined. In some instances, each anonymity level has by default, a predetermined number of types of relationships that can exist between the owner and the visitor. In some instances, the owner can adjust the number of types of relationships and further adjust the privacy settings associated with each type of relationship.

For example, the owner may be able to designate a visitor as having one of two types of relationships where the first type indicates a closer relationship than the other. Therefore, a visitor having the first type of relationship (e.g., friend, family, colleague, etc.) with the owner in the context of the second anonymity level may have access to more personal information of the user than a visitor not having the first type of relationship.

In process 616, it is determined whether the relationship status between the visitor and the owner is of a first type. If not, in process 620, accessibility to the second user name of the user is provided to visitor, without providing the legal name. If so, in process 618, accessibility to the legal identity of the user is provided to the visitor, for example. In some embodiments, other forms of personal information can be made available to the visitor (e.g., visitor user). For example, in process 622, accessibility to the first username of the user is provided to the visitor. Since the first username is associated with an anonymity level (e.g., the first level) that is more public than the second, a visitor having the first type of relationship with the user may be automatically granted access to information and content associated with the first anonymity level, or any anonymity level that is more public.

In process 624, web-based communication between the user and the visitor is facilitated, in some instances, upon request of either party.

FIG. 6C depicts a flow diagram illustrating an example process of facilitating interactions at a third anonymity level (e.g., private status) between the user (owner) and another user (visitor), according to one embodiment.

In process 632, content of the third content subset is presented to another user (visitor). The third content subset, in this example, is associated with the third anonymity level having, for example, a privacy status. Privacy settings attributed to the third anonymity level may typically include some settings that by default, maintain more of the owner's anonymity than the first (e.g., public status) and the second anonymity level (e.g., peer status). The default settings are generally user configurable/adjustable.

In process 634, the relationship status of the visitor with the owner at the third anonymity level is determined. Multiple types of relationships can exist between the user and visitors at the third anonymity level. In the example embodiment, the first type of relationship indicates a closer relationship with the user than the other types.

In process 636, it is determined whether the relationship status between the visitor and the user is of a first type. If not, in process 640, accessibility to the third user name of the user is provided to the visitor, without providing the legal name. If so, in process 638, accessibility to the legal identity of the user can be provided to the visitor, for example. In some embodiments, other forms of personal information (e.g., user name) can be made available to the visitor. For example, accessibility to the second username of the user is provided to the visitor. Since the second username is associated with an anonymity level (e.g., the second level) that is more public than the third, a visitor having the first type of relationship with the owner at the third anonymity level may be automatically granted access to information and content associated with the second anonymity level, or any anonymity level that is more public.

In process 642, web-based communication between the owner and the visitor is facilitated, in some instances, upon request of either party.

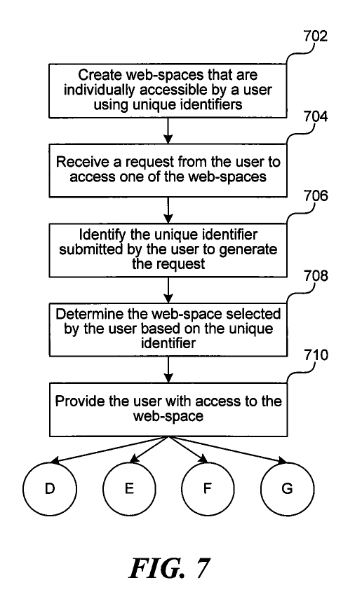

FIG. 7 depicts a flow diagram illustrating an example process of creating web-spaces that are individually user accessible using unique identifiers that represent multiple-identities, according to one embodiment.

In process 702, web-spaces that are individually user accessible (e.g., by the owner) using unique identifiers are created. Multiple web-spaces can be created at the request of the owner to representing multiple-identities in the social networking environment. Each web-space is typically individually accessed and populated with content that the owner feels is representative of the persona he/she wishes to express in a particular context. The owner can request to create any number of web-spaces. In most instances, only the owner can link each web-space to one another. To visitors, each of the web-spaces typically appears as a separate user account with that cannot be linked to the same owner.

In process 704, a request from the user (owner) to access one of the web-spaces is received. The owner may generate the request via a web-interface in any known and/or convenient manner. For example, the owner may logon to the social network with a username which is a unique identifier associated with a particular web-space. Therefore, in process 706, the unique identifier submitted by the owner to generate the request is identified, for example, from the username used by the owner for logging on to the social networking site.

In process 708, the web-space selected by the owner is determined based on the unique identifier. In process 710, the owner is provided with access to the web-space. The owner can perform a number of actions in the web-space once access is granted. The actions include those related to functions and/or services commonly provided in social networking environments. For example, the owner can add content to the web-space for sharing with related contacts or other visitors. The owner can also send messages (e.g., anonymously or non-anonymously) and chat with other users, etc.

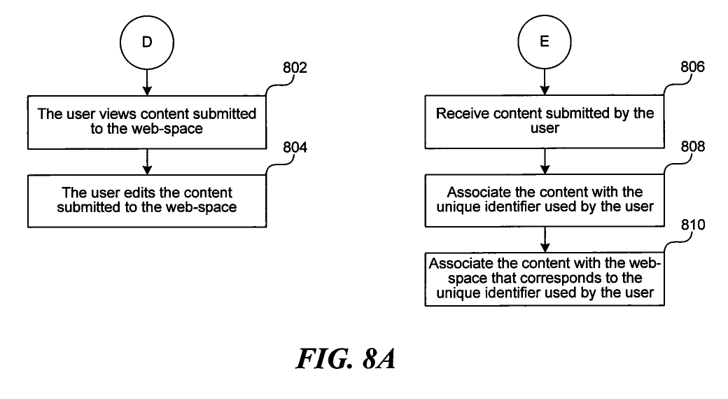

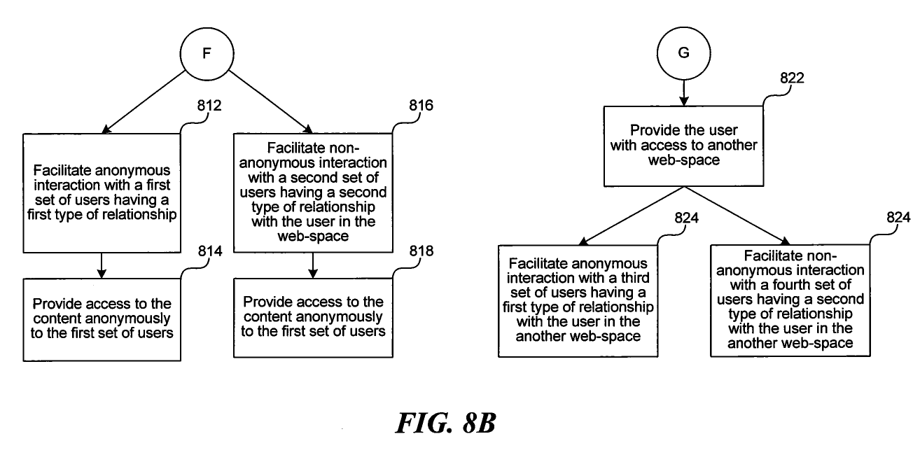

FIG. 8A depicts flow diagrams that illustrate example processes of content access in the web-space, according to one embodiment.

In process 802, the user (owner) views the content submitted to the web-space that he/she has logged in to. The web-space owner (e.g., account owner) can populate the web-space with content and design the web-space as desired. For example, the owner can add articles from another source or articles authored by the owner. In addition, the owner may wish to decorate the web-space home page with pictures/audio and/or to submit pictures to be shared with other users. In process 804, the user (owner) edits the content submitted to the web-space. Additionally, the owner may further edit content after submission.

In process 806, content submitted by the user is received. The user may submit content via any known and/or convenient manner including but way of example but not limitation, uploads, email attachments, SMS messages, instant messages, etc. In process 808, the content is associated with the unique identifier used by the user. Each unique identifier individually corresponds to a web-space. The unique identifier is, in one embodiment, one of the usernames specified by the user for logging on to one of the web-spaces.

In process 810, the content is associated with the web-space that corresponds to the unique identifier. Since the web-space has privacy settings different from the owner's other web-spaces, the content is, in most instances, attributed to the privacy settings set for the web-space. The content can be moved between web-spaces by the owner.

FIG. 8B depicts flow diagrams that illustrate example processes for providing anonymous and non-anonymous interactions with users based on the types of relationships among the users in another web-space, according to one embodiment.

In process 812, anonymous interactions with a first set of users having a first type of relationship is facilitated. In process 814, access to the content is provided anonymously to the first set of users. In this example embodiment, the first type of relationship with the user is one such that either based on default settings or user specified settings, visitors are not allowed to have direct and/or indirect access to the owner's personal information/identity information.

In process 816, non-anonymous interactions with a second set of users having a second type of relationship is facilitated. In process 818, access to the content is provided non-anonymously to the second set of users. In this example embodiment, the second type of relationship with the user is one of a closer relationship with the user than the first one. The second type of relationship generally allows visitors to have direct and/or indirect access to the owner's personal information/identity information.

In process 822, the user is provided with access to another web-space that he/she owns. In one embodiment, access to another web-space is granted with the user logs on with the username (e.g., unique identifier) that is uniquely associated with another web-space. In process 824, anonymous interactions with a third set of users having a first type of relationship with the owner in the another web-space is facilitated. In process 826, non-anonymous interactions with a fourth set of users having a second type of relationship with the owner in the another web-space is facilitated.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method of a social networking environment, the method, comprising:
managing anonymity levels of a set of user content provided by a user to the social networking environment;
wherein the set of user content comprises a first content subset having a first anonymity level corresponding to a privacy setting of a public status, a second content subset having a second anonymity level corresponding to a privacy setting of a peer status, and a third content subset having a third anonymity level corresponding to a privacy setting of a private status;
associating a first username, a second username, and a third username with the user; wherein the first username is associated with the first anonymity level, the second username is associated with the second anonymity level, and the third username is associated with the third anonymity level;
receiving newly submitted content from the user; and
assigning an anonymity level to the newly submitted content.

2. The method of claim 1, wherein, the set of user content is accessible by another user; wherein the accessibility comprises one or more of, searchability and visibility.

3. The method of claim 2, wherein, the first username, the second username, and the third username are not mutually identifiable by the another user.

4. The method of claim 3, wherein, the first content subset, the second content subset, and the third content subset, are not mutually identifiable by the another user.

5. The method of claim 1, wherein the anonymity level is assigned to the newly submitted content based on designation by the user.

6. The method of claim 5, further comprising:
providing access to the first content subset to the another user having a first type relationship with the user at the second anonymity level, when in accordance with specification by the user.

7. The method of claim 1, wherein, the privacy setting of the public status, the privacy settings of the peer status, and the privacy settings of the private status are individually adjustable by the user.

8. The method of claim 1, further comprising:
presenting content of the first content subset to the another user;
providing accessibility to a legal identity of the user to the another user;
wherein the legal identity is determined from one or more of, a legal name of the user and a first username of the user.

9. The method of claim 8, further comprising, facilitating web-based communications between the user and the another user.

10. The method of claim 1, further comprising:
presenting content of the second content subset to the another user;
determining a relationship status of the another user with the user at the second anonymity level;
responsive to determining that the relationship status is of a first type, providing accessibility to a legal identity of the user to the another user;
wherein the legal identity is determined from one or more of, a legal name of the user and a second username of the user; and
wherein the relationship status of the first type is a mutual relationship between the user and the another user.

11. The method of claim 10, further comprising:
responsive to determining that the relationship status is not of the first type, providing accessibility to the second username of the user to the another user; and
wherein the legal identity is not determine-able from the second username.

12. The method of claim 10, further comprising:
responsive to determining that the relationship status is of the first type at the second anonymity level, providing accessibility to the first username of the user to the another user.

13. The method of claim 10, further comprising:
responsive to determining that the relationship status is of the first type at the second anonymity level, facilitating web-based communications between the user and the another user.

14. The method of claim 10, further comprising,
presenting content of the third content subset to the another user;
determining a relationship status of the another user with the user at the third anonymity level;
responsive to determining that the relationship status is of a first type, providing accessibility to the legal identity of the user to the another user;
wherein the legal identity is determined from one or more of, the legal name of the user and third username of the user; and
wherein the relationship status of the first type is a mutual relationship between the user and the another user.

15. The method of claim 8, further comprising:
responsive to determining that the relationship status is not of a first type, providing accessibility to the third username of the user to the another user; and
wherein the legal identity is not determine-able from the second username.

16. The method of claim 15, further comprising:
responsive to determining that the relationship status is of a first type, facilitating web-based communications between the user and the another user.

17. A method of a web-based social networking platform, the method, comprising:
creating a plurality of web-spaces that are individually accessible by a user using a plurality of unique identifiers; wherein each of the plurality of web-spaces is individually associated with each of the plurality of unique identifiers;
receiving a request from the user to access a specific one of the plurality of web-spaces;
determining the specific web-space of the plurality of web-spaces based on a unique identifier of the plurality of unique identifiers submitted by the user to generate the request; and
providing the user with access to the specific web-space of the plurality of web-spaces.

18. The method of claim 17, wherein, the access to the specific web-space of the user comprises, one or more of:
viewing content submitted to the specific web-space of the plurality of web-spaces; and
editing the content submitted to the specific web-space of the plurality of web-spaces.

19. The method of claim 18, wherein, the access to the specific web-space of the user, further comprises, one or more of:
facilitating anonymous interaction with a first set of users having a first type of relationship with the user in the web-space; and
facilitating non-anonymous interaction with a second set of users having a second type of relationship with the user in the specific web-space.

20. The method of claim 17, further comprising:
receiving content submitted by the user; and
associating the content with the web-space of the plurality of web-spaces specified by the user; wherein the content is associated with one of the unique identifier of the user associated with the one of the plurality of web-spaces.

21. The method of claim 20, further comprising,
providing the first set of users with access to the content anonymously; and
providing to the second set of users with access to the content non-anonymously.

22. The method of claim 17, further comprising:
providing the user with access to another web-space of the plurality of web-spaces;
facilitating anonymous interaction with a third set of users having a first type of relationship with the user in the another web-space; and
facilitating non-anonymous interaction with a fourth set of users having a second type of relationship with the user in the another web-space.

23. The method of claim 22, wherein, the accessibility of the content associated with the web-space of the plurality of web-spaces to the third and fourth sets of users are adjustable by the user.

24. The method of claim 22, wherein, the accessibility of content associated with the another web-space of the plurality of web-spaces to the first and second sets of users is adjustable by the user.

25. A system, comprising:
a user database to store user information;
a content database to store a plurality of content submissions;
a user account module to manage a plurality of identities associated with a user in a social network;
a privacy setting module to track and enforce the privacy settings associated with each of the plurality of identities associated with the user in the social network; and
a relationship tracker agent to manage a plurality of sets of contacts of the user associated with each of the plurality of identities.

26. The system of claim 25, further comprising, a communications module to facilitate web-based communications between the user and a contact of the plurality of the sets of contacts of the user.

27. The system of claim 26, wherein the communications module further manages anonymity level of the user in the web-based communication based on the identity of the plurality of identities that the contact is associated with.

28. A computer implemented social networking system, the social networking system characterized in that a user has a plurality of identities, each identity having associated content, and each identity having an associated anonymity level which determines how other users are entitled to interact with each identity and associated content, and how other users perceive each identity.
